(19) United States
(12) Patent Application Publication
(10) Pub. No.: US 2014/0201330 A1
(43) Pub. Date: Jul. 17, 2014

(54) METHOD AND DEVICE FOR QUALITY MEASURING OF STREAMING MEDIA SERVICES

(71) Applicants: José Antonio Lozano Lopez, Madrid (ES); Juan Manuel González Muñoz, Madrid (ES); Jesús Barbero Villaseca, Madrid (ES); Álvaro Rodríguez Perez, Madrid (ES)

(72) Inventors: José Antonio Lozano Lopez, Madrid (ES); Juan Manuel González Muñoz, Madrid (ES); Jesús Barbero Villaseca, Madrid (ES); Álvaro Rodríguez Perez, Madrid (ES)

(73) Assignee: TELEFONICA, S.A., Madrid (ES)

(21) Appl. No.: 14/110,114

(22) PCT Filed: Apr. 2, 2012
(86) PCT No.: PCT/EP12/55996

§ 371 Date: Mar. 27, 2014

(30) Foreign Application Priority Data
Apr. 5, 2011 (ES) P201130541

(51) Int. Cl. H04L 29/06

(52) U.S. Cl. CPC H04L 65/60
USPC 709/219

(57) ABSTRACT

Method and probe device for quality measuring in IP streaming of audio, video, or a synchronized mix of both, performing:
receiving a streaming media flow at a user's end,
measuring at least one network parameter which indicates QoS and/or QoE,
extracting frames from the streaming at the user's end,
analyzing the frames at the user's end by searching for determined errors and delivering at least a quality parameter defined by certain results of said searching;
correlating each measured network parameter and each delivered quality parameter at the user's end and returning the results to the IP network operator though a control and configuration interface.

The operator uses the control and configuration interface to configure at the user's end how to perform the correlation between the parameters, taking into account in said correlation the user's preferences described by an ontology.

### TECHNICAL FIELD OF THE INVENTION

The present invention deals with a method and a probe device for measuring quality parameters, related to Quality of Service (QoS) and Quality of User Experience (QoE) parameters, of services including streaming video, streaming audio and streaming media hosting services.

### BACKGROUND OF THE INVENTION

Streaming media is a transmission technology that allows users to view or hear files as they are transferred by telecommunication networks. Streaming is in contrast to first downloading files to user equipment (computer, smartphone . . . ), which typically requires users to wait until the entire object is finished downloading. The ability to stream files is usually found on websites, allowing viewers to experience the files in real time. The most common types of streaming media typically include audio, video, or a synchronized mix of the two.

Audio streaming is created by running a digital sound file through an encoder, and then usually placing it on a website for users to hear. Video streaming is often found on the Internet (most quality video streams are specifically made for this medium), but it does not always include sound (an example of a basic video file that does not need audio is a stream of photographs). One of the most useful and favourite types of streaming media includes audio and video that are synchronized with each other, which ensures that the image on the screen and the audio from the speakers match up, making the viewing experience appear high-quality.

The quality of the files typically depends on the speed of the user's Internet connection. Most computers can play audio files quite easily, but video streams typically take up more bandwidth. This means that they can take longer to stream continuously, resulting in several pauses as the transfer rate tries to catch up. Even on slower connections, though, streaming media usually still offers a faster alternative to downloading.

A media hosting provider can deliver streaming audio and video through live or on-demand webcasting, even by free (e.g., YouTube, Vimeo, and similar sites that are primarily international video sharing sites, which host user-generated media and stream it).

So, video streaming is a key piece for an ever increasing number of telecommunications services as video conferencing, video on demand, video blogs, live TV over Internet, etc. Although, some of these services are delivered using “best effort” quality scheme, being able to measure the video flows quality is an important question for companies providing telecommunications managed services.

Video streaming signals transported over Internet Protocol (IP) networks are affected by a number of possible degrading factors as packet delay, jitter, packet loss, etc. These factors get manifested at the image as artefacts distorting the image that appears at the rendering device. As the artefacts exceed a threshold, they become visible to the human eye impacting on the quality of service as perceived by end users. A video flow can show the following artifacts that impact user's perceived quality: frozen (a video flow is frozen when there's no change between frames for a specific period of time) and pixilation (a video flow shows this problem when pixel artifacts are perceived by users to a non-admissible degree).

IP networks are characterized for being highly distributed and so is the measurement on it. The video measurement algorithms are distributed throughout the network in order to achieve the end-to-end view of video services. But another issue to be considered is regarding how to control the probes as they are highly distributed infrastructure. The work of reference was presented by the Internet Engineering Task Force (IETF) in 2000 and is known as policy based management. The IETF policy working group continues to be employed by industry and other standardization bodies such as the Third Generation Partnership Project (3GPP), which has decided to use COPS as the policy protocol for the interface between the Policy Enforcement Point located in the edge router (e.g., Gateway GPRS Serving Node) of the network and the Policy Decision Point that communicates with the user interface through a policy repository protocol. Nonetheless, the protocols (COPS, SNMP, etc.) designed for these control and government issues are network oriented. Therefore, it is important to provide operators with means to control infrastructures from the business and service layer.

On the other hand, there is a current need for operators to assure Internet Protocol television (IPTV) services through which Internet television signals are delivered using the architecture and networking methods of the Internet Protocol Suite over a packet-switched network infrastructure (e.g., the Internet and broadband Internet access networks), instead of being delivered through traditional radio frequency broadcast, satellite signal, and cable television (CATV) formats.

The quality perceived for users of IPTV services depends on the quality of the image they are receiving. Current QoS/QoE methods measure the network parameters directly from Management Information Bases (MIBs) of the Network Elements (NEs) or using some probes located at different points on the network. These probes can gather working parameters from the service protocol stack (IP, TCP, UDP, HTTP, etc.) as packet delay, packet loss, packet jitter, etc., which can be collected by using Simple Network Management Protocol (SNMP), for example.

The main disadvantage of analyzing network parameters where the probe is installed is that only an estimation of the end users perception can be provided. Network parameters measurements can only provide estimation more or less precise; from these data perceived quality is estimated (guessed), but it is an indirect measurement because, for example, the effect of packet losses depends on the type of frame where it happens, that means that the same value could produce different effect on the image. Moreover, methods for estimating the quality of the video signals based on network parameters measurements require expensive off-line resources with high processing capabilities. Hence, there is a lack of tools to effectively know the quality of the image that IPTV services end users are really receiving.

Other current solutions are based on a perceived video quality which is measured provided that the full reference video signal is available. These approaches rely on the existence of the full reference video at the measurement point, which is not realistic for the Service Providers realm, where signals have to be distributed through communication networks where they will suffer losses, delays, etc. At the end point it is not possible to have such full reference. In a commercial deployment of a network to provide customers with video flows, it is not possible to have the original video signal at the end point as it is transported by a network were the signal can suffer from jitter, delay, packet loss, etc. Thus there's no way to assure that the signal is exactly the one at the beginning.

### SUMMARY OF THE INVENTION

The present invention serves to solve the aforesaid problem by providing a method and device for measuring quality parameters related to QoE of streaming media services provided over an IP network.

The solution presented here makes the perceptual quality of service sensitive to both the user's context and the operator's interests.

The present proposal is to provide a low cost device and a procedure to measure on-line the quality of IP streaming media services according to the end user perception, which is based on the quality of the media contained in the streaming flow to be distributed over the Internet Protocol (e.g., based on the actual quality of the images in a video streaming). No reference signal (the full video) is needed, which makes the invention more suitable for its use in live environments where the full reference (video) signal is not available at measurement points (e.g., the invention makes possible to get a perceptual video quality which simplifies what is described in ITU-T J.144 recommendation). It allows and adaptive control, since the proposed measuring device is located at the end users premises, which means that works on quite different environments requiring adaptation capabilities which can be easily incorporated on the proposed device.

Furthermore, the invention allows the perceptual measuring of streaming media flows to be correlated with information from technical network parameters extracted at the same point. In addition, it implements an interface for an operator to control the measurement process using high level orders, as well as it makes the algorithms aware and self-adjustable to the characteristics and contents of specific streaming flows.

In accordance with one aspect of the invention, there is provided a method for quality measuring of streaming media services, including streaming of audio, video, or a synchronized mix of the two media, deliverable over the Internet Protocol. The method comprises the following steps:
receiving a streaming media flow at a user's end,
measuring at least one network parameter which indicates QoS and/or QoE of packet transmission over the IP network,
extracting at the user's end a plurality of frames from the streaming media flow to be analyzed,
analyzing the plurality of frames at the user's end by searching for determined errors in the frames and delivering at least a quality parameter of the frames, the quality parameter defined by certain results of said searching;
performing correlation at the user's end between each measured network parameter and each delivered quality parameter,
delivering results of the correlation from the user's end to an operator of the IP network though a control and configuration interface.

The operator can configure by means of the control and configuration interface at the user's end the step of correlation between the aforementioned parameters taking into account user's preferences which are described by an ontology model. The ontology allows the operator to describe the errors for searching in the frames and the results to be delivered using said control and configuration interface.

In accordance with a further aspect of the invention, there is provided a probe device, connectable to a user terminal from which receives an input streaming media flow, which comprises processing means for performing the method described before using said input streaming media flow and retransmitting means for delivering the input streaming media flow as an output.

In accordance with a last aspect of the invention, it deals with a computer program comprising program code means which execute the method described before, when loaded into processing means of a device as defined above, said processing means can be any form of programmable hardware: such as a general purpose processor of a computer, a digital signal processor, a field-programmable gate array (FPGA), an application-specific integrated circuit (ASIC), a micro-processor, a micro-controller, etc

There are a number of advantages that the invention brings to current state of art technologies, namely:
Real perceived quality measured by this proposal versus network parameters based estimation by most of current state-of-the-art solutions. The present invention clearly differs from the state-of-the-art in that, for example, it is capable of looking for artefacts in the very media (frame of the input video streaming) and measuring directly the quality of the streaming (video image). Moreover, the invention allows the correlation between the perceived quality and network parameters for operational purposes. On the contrary, most of the existing solutions only provide quality estimations based on network performance parameters, instead of using the very media.
Zero reference perceived quality measurements. Most of the standardized algorithms for measuring video quality need full reference, which is a major drawback for using them in telecommunication services. The invention allows an operator to link probe configuration to service needs, for instance, the technical parameters to be measured can be different depending on the content. In addition a pattern that models user interests can be applied.
It is possible to adjust the sensitivity and configuration of the probe in real time. Furthermore it is possible to change it so that the probe can work without coding it again, which dramatically reduces time to market of new monitoring needs. Sensitivity can be adaptively adjusted in real time to match users' perception by means of specifying the type of contents, kind of users, etc. Also, context aware configuration is possible.
The management of a plurality of probes as proposed is scalable. Each probe acts individually, checking their own environment and the indications of operators embedded in the knowledge database. They behave according to their own environment. Only high level indications are needed from operators. A semantic information model to provide a knowledge oriented interface for policy driven control and management is implemented in the proposed probe device.

### DESCRIPTION OF THE DRAWINGS

To complete the description that is being made and with the object of assisting in a better understanding of the characteristics of the invention, in accordance with a preferred example of practical embodiment thereof, accompanying said description as an integral part thereof, is a set of drawings wherein, by way of illustration and not restrictively, the following has been represented:

FIG. 1.—It shows a probing device connectable at the user end for measuring quality of video streaming, according to a possible embodiment of the invention.

FIG. 2.—It shows a block diagram of the functional architecture of the probing device, according to a possible embodiment of the invention.

FIG. 3.—It shows a schematic diagram of video processing for the analysis of the video streaming performed by the probing device at the user end, according to a preferred embodiment of the invention.

FIG. 4.—It shows a schematic diagram of the video analysis, according to a preferred embodiment of the invention.

FIG. 5.—It shows an ontology chart of a knowledge model used for governance of the probing device, according to a possible embodiment of the invention.

### DETAILED DESCRIPTION OF THE INVENTION

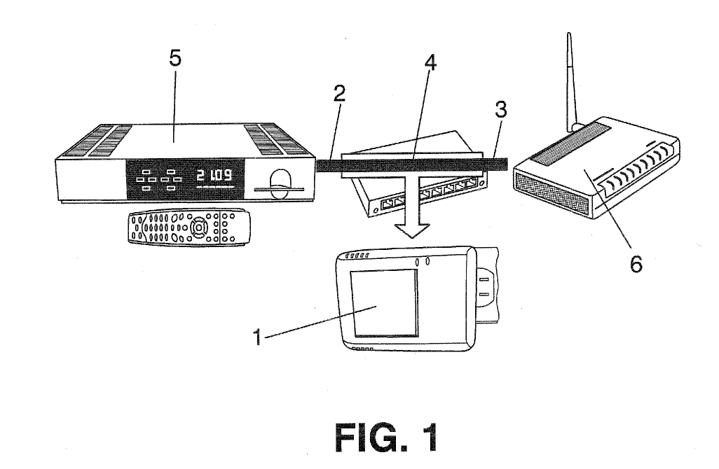

FIG. 1 shows one possible embodiment of the invention implementing a Video Intelligent Probe device (1), which can receive an IP video flow through an input interface (2) and pass it to an output interface (3). This device (1) is suitable for being connected by IP connection means (4) between a user terminal, for example, a Set Top Box (5) providing the input video flow and a customer router (6) which relays it to an IP network. Another possibility is integrating the functionality of device (1) within the own user terminal.

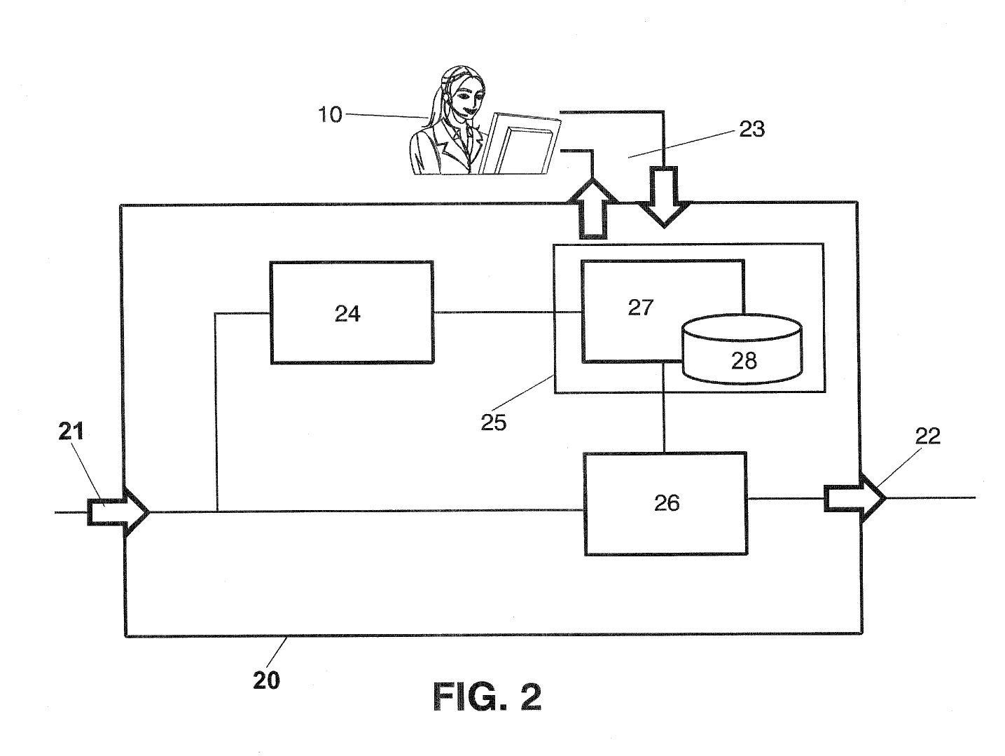

FIG. 2 shows a block diagram of the functional architecture of a probe device (20) as the proposed before in FIG. 1. The device (20) is provided with three interfaces: one for input video (21), another one for output video (22) and a control and configuration interface (23) for the operator (10) to manage the configuration of the whole device (20) and get the quality measurements result from said device (20). From the input video (21) interface, the device (20) extracts the video frames to be analysed by a video processing component (24), which is in charge of analysing and detecting video artefacts that a customer can perceive. The video processing component (24) is a zero-reference algorithm to analyze the input video flow and can be configured depending on a number of parameters such as the ratio of pixels with errors in a frame or the number of frames presenting artefacts in a certain amount of time. Besides, network parameters such as packet loss and jitter in the video streaming are measured by a network measurements component (26) whose operation is well known at the state-of-art technologies. The network measurements component (26) enables the combination of direct quality measures by the video algorithm with perceived measures so that problems in the video flow can be anticipated. This network measurements component (26) can implement an SNMP agent to collect measures from the MIBs of NEs and can apply different known algorithms, such as clock skew algorithms, to measure the needed parameters. Once carried out these network measurements, the video streaming passes transparently into the output video (22) interface for its retransmission from the probe device (20) to an IP network. An autonomic behaviour of this probe device (20) is granted by a governance component (25), which in turn comprises an adaptive processing component (27) empowered by a knowledge database (28), in charge of performing an adaptive control of the quality measurements. The governance component (27) interfaces with the operator (10) by means of the control and configuration interface (23), through which the operator (10) is able to adjust the sensibility of the detection according to user profiles, the characteristics of video contents, etc. The adaptive processing component (27) decides which video quality profile is to be applied to configure the video processing component (24) and, in addition, can also capture perceived quality video measurements from the output of said video processing component (24) together with the network measurements in order to further analyze them in a batch process by correlation. These two components, for video and adaptive processing, are explained in more detail below.

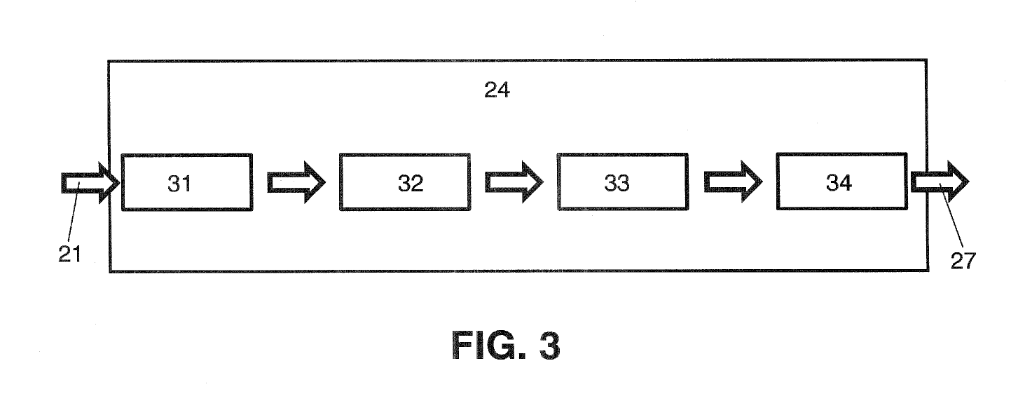

The video processing component (24) implements a four-stage procedure depicted in FIG. 3, comprising:
video streaming reception means or stage (31) connected to the interface of the input video (21),
   an optional video conversion stage carried out by conversion means (32), analysis means (33) which handle the video flow given in a certain format by the previous stages, and
a final stage of result delivering means (34) connected to the adaptive processing component (27).

The reception stage (31) extracts the frames from the input video stream. Each frame is an input to the conversion stage (32) where the frames are converted to a colour format for image and video processing, preferably, a YUV format, e.g., YUV420p. The YUV format is a colour space where Y stands for the luminance component and U and V are the chrominance components. The YUV 420p format obtains a black and white frame easily by taking the Y component from the converted frame. The main reason to choose the YUV 420p format is improving efficiency in the analysis stage, since the analysis means (33) can work with black and white frames so the Y component from the converted frame is the only one needed. Also, in most of the IPTV broadcast systems, the YUV 420p is the emission format, so in many cases the conversion stage can be omitted.

The analysis means (33) are capable of searching specific errors on the images of the video stream, preferably these two: frozen image and pixelation. For the frozen image analysis, each frame is compared to the previous one obtaining the difference of movement between them. If there is no difference between two consecutive frames, the image of the video stream is frozen, i.e., the image is frozen when the ratio or % of movement is zero. The pixelation analysis can be divided into two phases: the first one is an edge filtering and the other, a Dirac delta analysis. The edge filter can be implemented by a Canny edge detector of the OpenCV library and detects the pixels of the image which are candidate for being an edge by using thresholding with hysteresis. Two thresholds, high and low, are used by the edge filter: the pixels which have a higher gradient than the high threshold are marked as edge, the ones which have a gradient between the high and the low threshold are marked as possible candidates for being edge pixels and the ones which have a lower gradient than the low threshold are discarded to be edge pixels. Regarding the Dirac Delta analysis, this phase of the analysis stage detects the parts of the frame which have the same or a very similar Dirac Delta value, the Dirac Delta value being a specific zone of the frame represents it's texture. The frame is divided into square components, the Delta Dirac values are calculated for each component and by comparing these values the algorithm can discover the image zones which have similar texture.

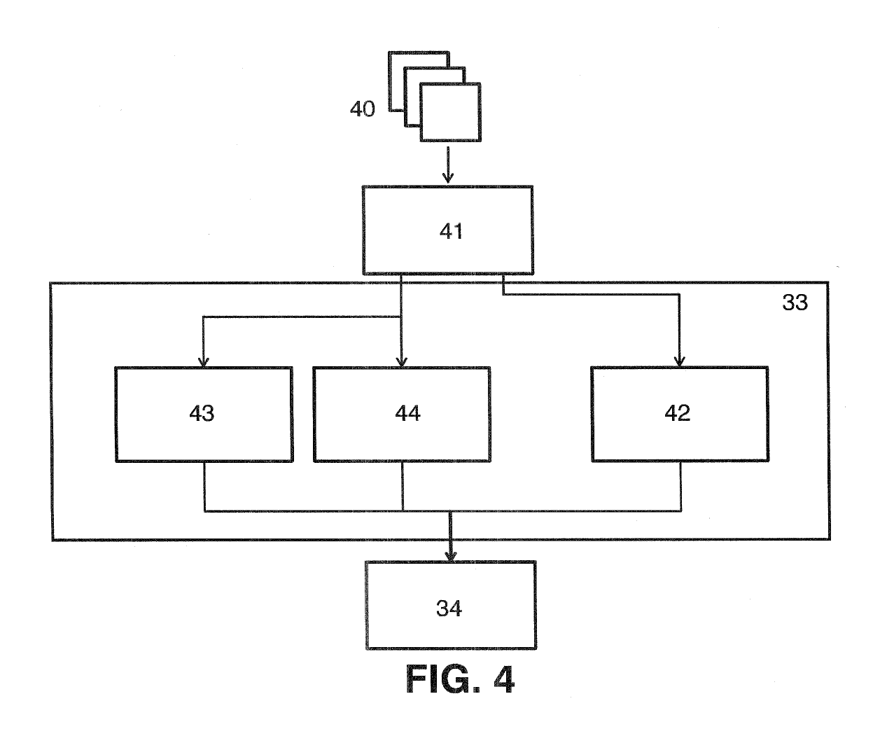

The artefacts that compose a pixelation error have particular characteristics: they have a quadrangular shape and they have a similar texture. Taking into account these two characteristics, the two phases of said pixelation analysis, edge filtering and the calculation of the Dirac delta values, are capable of locating the pixelation errors on an image. FIG. 4 summarizes the whole processes of pixelation and freeze image detection executed by the analysis means (33). The frames (40) from the input video stream are converted, if necessary, from the emission format to YUV 420p format so that the Y components of the frames (40) are extracted (41). Each Y component is the input for the next stages of the analysis means (33). In the movement measurement stage (42), each frame is compared to the previous one and the result is the percentage of movement. The edge filter stage (43) applies a Canny Edge Filtering to the frame and the Dirac delta stage (44) calculates the Dirac Delta value of the frame zones. The results of both Edge filter stage and Delta dirac stage are combined and the result are the percentage of the image zones which have very similar texture and square edges, like pixels artefacts do. Finally the output of the analysis stage goes to the result delivering means (34) and this output is the combination of the results from the frozen image analysis and the pixelation analysis, presenting the error artefacts of the image and assuring either if the image is frozen or if it has a certain percentage of pixelation artifacts.

Thus, the final stage carried out by the result delivering means (34) gives to the adaptive processing component (27) the image percentage of movement of the frames and percentage of frames that presents pixelation artefacts.

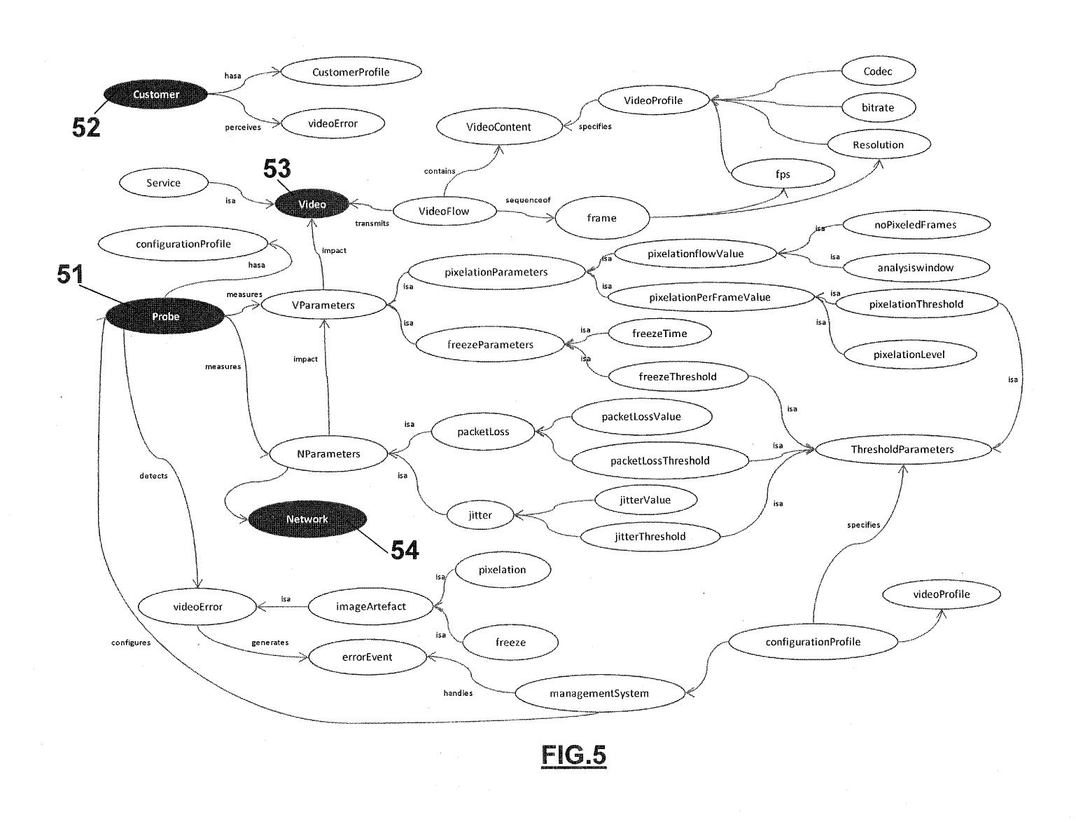

The adaptive processing component (27) uses a semantic model, shown in FIG. 5, which can be described by a semantically rich language, that is an ontology, e.g. the Web Ontology Language also known as OWL. In accordance to an embodiment of the invention, the ontology describes parameters and their relation according to four realms: Probe (51), Customer (52), Video (53) and Network (54). The adaptation processing is based in reasoning techniques that enable this component to match high level views of business and services from the operator (10) into low level network metrics and video quality profiles, which result from the network measurements component (26) and the video processing component (24) respectively. The adaptive processing component (27) is configured by defining a semantic profile, a profile being the set of parameters that can be measured and characterize a specific domain. The adaptive processing component (27) also comprises a semantic description of what each parameter of the profile means within each domain and how the parameters are related between different domains.

The relationships between the different domains or realms are captured through the use of the ontology, e.g. OWL. The four realms—Probe (51), Customer (52), Video (53) and Network (54)—, shown in FIG. 5 and which are described by this semantic model, refer to:

Probe (51): It is described the probe device (20) itself, what kind of parameters are measured, the kind of video errors that can be detected and the configuration of the probe, including which parameters are to be configured to adjust the working area of the probe device (20). It is important to highlight that the sensitivity of the probe device (20) is so adjusted according not only to the kind of content but the users preferences, captured by control and configuration interface (23) from extern systems. Although it is a subjective issue, the proposed probe is able to handle it.

Customer (52): Since perception is something subjective, this realm describes customer preferences, which can be personal preferences, e.g., customer's interest in football and so, the probe has to be more sensitive to these type of contents. This information is included into the semantic model and affected to the reasoning.

Video (53): It is described the technical parameters of the video flow, e.g., codec, bitrate, resolution, etc., but it is also linked to the kind of content to enable the probe to put together technical parameters with type of contents which are in turn preferences of the customer.

Network (54): Since services converge at network level, it is important to semantically describe what can be obtained from the network. This concept is linked with the video through description on impacts. Thus the reasoning process can find paths from customers to network performance for video applications.

The presented semantic model, as the one depicted in FIG. 5, can be changed at any time and distributed to the probes without coding them again. It can be updated, extended or even shorten and then distributed again to the probes for them to work with the new domain description. This means that the presented invention allows the operator to introduce new concepts for the probe to manage them, and this can be done with minimum development.

Note that in this text, the term “comprises” and its derivations (such as “comprising”, etc.) should not be understood in an excluding sense, that is, these terms should not be interpreted as excluding the possibility that what is described and defined may include further elements, steps, etc.

1. A method for measuring quality parameters of streaming media services provided by an IP network, comprising:
receiving a streaming media flow at a user's end,
measuring at least one network parameter which indicates Quality of Service or Quality of User Experience of packet transmission over the IP network,
characterized by further comprising:
extracting at the user's end a plurality of frames from the streaming media flow to be analyzed,
analyzing the plurality of frames at the user's end by searching for determined errors in the frames and delivering at least a quality parameter of the frames, the quality parameter defined by certain results of said searching;
performing correlation at the user's end between each measured network parameter and each delivered quality parameter,
delivering results of the correlation from the user's end to an operator (10) of the IP network though a control and configuration interface (23).

2. The method according to claim 1, wherein the correlation at the user's end is configured by the operator (10) through the control and configuration interface (23) taking into account user's preferences which are described by an ontology.

3. The method according to claim 2, wherein the errors for searching in the frames and the results to be delivered are described by the ontology and configured by the operator (10) through the control and configuration interface (23), taking into account whether the streaming media is selected from audio, video and a synchronization of both, and the described user's preferences.

4. The method according to any preceding claim, wherein the streaming media comprises video and the errors for searching in the frames are selected from frozen image and pixelation.

5. The method according to claim 4, wherein analyzing the plurality of frames at the user's end comprises comparing each frame with at least a previous one and the results to be delivered comprise an indication of difference of movement between the compared frames.

6. The method according to either claim 4 or 5, wherein analyzing the plurality of frames at the user's end comprises an edge filtering and calculating Dirac Delta values of a certain zone of the frames and the results to be delivered comprise an indication of the frames presenting pixelation.

7. The method according to any claim 4-6, wherein the frames extracted to be analyzed at the user's end are in a video format using black and white coloured frames.

8. The method according to any preceding claim, wherein the, at least one, measured network parameter is selected from packet delay, packet loss and packet jitter.

9. A probe device (1) for measuring quality parameters of streaming media receiving a streaming media flow at a user's end, the probe device being connectable at a user's end for receiving a streaming media flow and comprising receiving means of measured network parameters which indicate Quality of Service or Quality of User Experience of packet transmission over the IP network services provided by an IP network, and the probe device being characterized by comprising processing means configured to implement the method set out in any previous claim.

10. The probe device according to claim 9, wherein the probe device (1) is connectable between a sep top box (5) and a IP router (6) at the user's end.

11. The probe device according to claim 9, wherein the probe device is integrated in a sep top box (5) and connectable to a IP router (6) at the user's end.

12. A computer program comprising program code means adapted to perform the steps of the method according to any claims from 1 to 8, when said program is run on a computer, a digital signal processor, a FPGA, an ASIC, a micro-processor, a micro-controller, or any other form of programmable hardware.
